(19) United States
(12) Patent Application Publication
(10) Pub. No.: US 2012/0162122 A1
(43) Pub. Date: Jun. 28, 2012

(54) FORCE SENSITIVE DEVICE WITH FORCE SENSITIVE RESISTORS

(75) Inventor: Bernard O. Geaghan, Salem, NH (US)

(73) Assignee: 3M Innovative Properties Company

(21) Appl. No.: 12/979,124

(22) Filed: Dec. 27, 2010

(51) Int. Cl. G06F 3/045; G06F 3/041; G01L 1/00

(52) U.S. Cl. 345/174; 702/41; 345/173

(57) ABSTRACT

A force sensitive device comprises a force sensor and a control system. The control system applies drive signals to the force sensor and measures receive signals that are responsive to forces associated with contacts made to the force sensitive device. The control system determines location and force information of one or more contacts on the force sensor based upon the receive signals.

### BACKGROUND

Force sensitive resistive material has variable resistance in response to the amount of pressure imposed. Force sensitive resistors comprise force sensitive resistive material. One type of force sensitive resistors comprises a conductive polymer film which exhibits a decrease in resistance with an increase in the force applied to its active surface. A force sensitive device can be implemented with a number of force sensitive resistors located under a display, so that the device can be used as a touch sensitive device.

Touch sensitive devices allow a user to conveniently interface with electronic systems and displays by reducing or eliminating the need for mechanical buttons, keypads, keyboards, and pointing devices. For example, a user can carry out a complicated sequence of instructions by simply touching an on-display touch screen at a location identified by an icon. There are several types of technologies for implementing a touch sensitive device including, for example, resistive, infrared, capacitive, surface acoustic wave, electromagnetic, near field imaging, etc. A touch sensitive device may also employ force sensing technology.

### SUMMARY

In one embodiment, a force sensitive system comprising a force sensor, a signal source, a measurement circuit, and a processing unit, is disclosed. The force sensor may comprise a first array of input electrodes on a first layer, a second array of electrodes on a second layer, the second array of electrodes arranged transverse to the first array of electrodes to form intersections where electrodes of the first array cross electrodes of the second array, and force sensitive resistive material disposed between the first layer and the second layer at at least some of intersections. The first array of input electrodes is not directly coupled to the measurement circuit. The signal source is coupled to the first array of electrodes and configured to provide a drive signal to one or more electrodes. The measurement circuit is coupled to the second array of electrodes and configured to measure signals thereon and the interface between the measurement circuit and the second array of electrodes is passive. The processing unit is configured to determine location information related to a contact on the force sensitive sensor based upon the signals received by the measurement circuit.

In another embodiment, a method for determining location information related to a contact made on a touch sensitive surface of a device is disclosed. The touch sensitive surface has a first array of drive electrodes on a first layer, a second array of electrodes on a second layer, the electrodes of the second array of electrodes arranged transverse to the first array to form intersections where electrodes of the first array cross electrodes of the second array, and force sensitive resistive material disposed between the first layer and the second layer at least some of the intersections. The method comprising: (1) applying a drive signal by a signal source to at least one drive electrode of the first array while applying a reference signal to the other electrodes of the first array; (2) receiving first receive signals occurring on the second array of electrodes, the first receive signals responsive to contact made to the touch sensitive surface, by a measurement circuit passively interfaced to the second array of electrodes; (3) repeating step (1) and step (2) for at least a plurality of electrodes of the first array; and (4) based on the first receive signals, determining by a processing unit location information related to the contact made to touch sensitive surface.

In one other embodiment, a force sensitive system comprising a force sensor, a signal source, a measurement circuit, and a processing unit, is disclosed. The force sensor may comprise a first array of input electrodes, a second array of electrodes, and force sensitive resistive material disposed between the electrodes of the first array and the second array. The signal source is coupled to the first array of electrodes and configured to provide a drive signal to one or more electrodes. The measurement circuit is coupled to the second array of electrodes and configured to measure voltage signals thereon. The processing unit is configured to determine location information related to a contact on the force sensitive sensor based upon the signals received by the measurement circuit.

In yet another embodiment, a force sensitive system comprising a force sensor, a signal source, a measurement circuit, and a processing unit, is disclosed. The force sensor may comprise a first array of input electrodes, a second array of electrodes, at least one electrode of the second array spatially separated from the electrodes of the first array, and force sensitive resistive material disposed between the electrodes of the first array and the second array. The signal source is coupled to the first array of electrodes and configured to provide a drive signal to one or more electrodes and configured to provide a high impedance to one or more electrodes. The measurement circuit is coupled to the second array of electrodes and configured to measure signals thereon. The processing unit is configured to determine force information related to pressure applied on the force sensitive sensor based upon the signals received by the measurement circuit.

### BRIEF DESCRIPTION OF THE DRAWINGS

The accompanying drawings are incorporated in and constitute a part of this specification and, together with the description, explain the advantages and principles of the invention. In the drawings,

FIG. 1 is a block diagram of an exemplary force sensitive device;

FIG. 2 illustrates a perspective view of an exemplary embodiment of a force sensor;

FIG. 3 illustrates a simplified schematic of a force sensitive device;

FIG. 4A is a cross-sectional view of an exemplary force sensor;

FIG. 4B is a cross-sectional view of the exemplary force sensor in FIG. 4A with pressure applied;

FIG. 5 illustrates a modular diagram of an embodiment of a force sensitive device;

FIG. 6A illustrates a simulated circuitry of a control system for an exemplary force sensitive device;

FIG. 6B illustrates the exemplary force sensitive device in FIG. 6A with contacts imposed;

FIG. 6C illustrates another simulated circuitry of a control system for an exemplary force sensitive device;

FIG. 7 is an exemplary force-resistance graph;

FIG. 8 illustrates an exemplary flowchart for a method of determining force and position information;

FIG. 9 illustrates an exemplary circuit at an electrode intersection during a measurement step;

FIG. 10 illustrates another exemplary flowchart for a method of determining force and position information;

FIG. 11A illustrates an exemplary circuit at an electrode intersection during a measurement step in one embodiment; and

FIG. 11B illustrates an exemplary circuit at an electrode intersection during another measurement step in the same embodiment as FIG. 11A.

### DETAILED DESCRIPTION

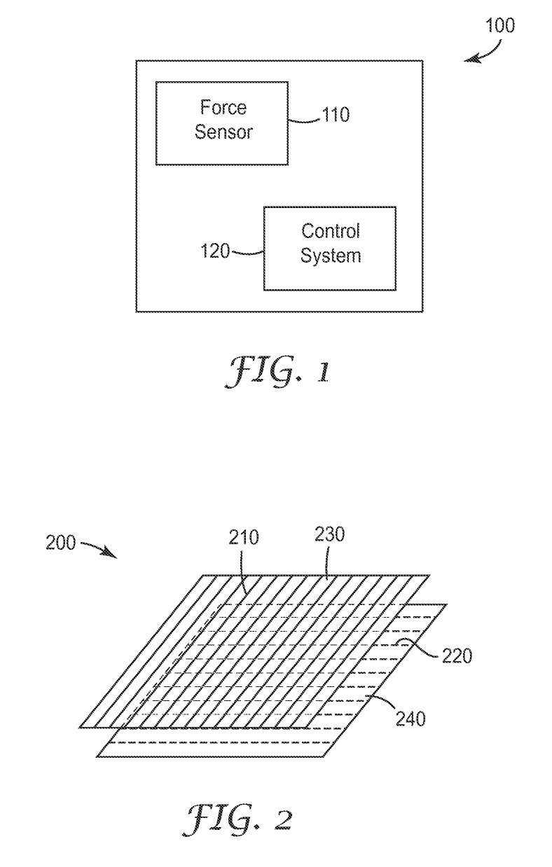

Force sensitive device 100 may comprise a force sensor 110, referred as force transducer or pressure sensor herein, and a control system 120, as illustrated in FIG. 1. In this disclosure, a force sensor 110 typically comprises force sensitive resistive material that changes its resistance value based on the magnitude of force imposed. When one or more contacts are applied on the force sensor 110, the control system 120 receives signals emanating from the force sensor and determines therefrom force magnitude and location information related to the one or more contacts applied on the force sensor. The force sensitive device 100 may be used to measure force magnitude and output the force magnitude to subsequent response systems. For example, the force sensitive device 100 may be placed under a floor tile and an output of force magnitude may activate a message or content on an adjacent display depending on the weight of a person standing on the tile.

The force sensitive device 100 may also be used as a component of a touch screen to detect and provide location information related to one or more touches on the screen. For example, the force sensor 110 is substantially opaque and may be placed behind a display such as a flexible electrophoretic display. In another example, the force sensitive device 100 may be used in e-Readers that are dedicated electronics devices for reading digital books. Compared with other touch technologies, force sensitive devices often provide low power consumption and low cost. In some embodiments, the present disclosure is directed to force sensitive devices with low power consumption and low cost control systems.

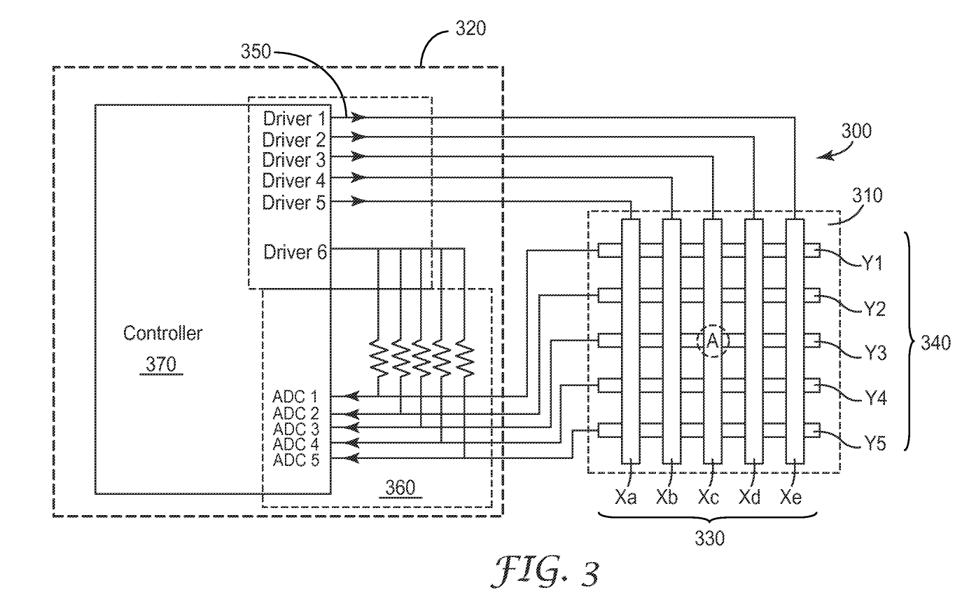

FIG. 2 illustrates a perspective view of an exemplary embodiment of a force sensor 200. In one embodiment, the force sensor 200 has a first array of electrodes 210 and a second array of electrodes 220. The force sensor 200 may have a first layer 230 and a second layer 240, while the first array of electrodes is on the first layer and the second array of electrodes 220 is on the second layer 240 respectively. The force sensor 200 may have any number of electrodes, matrix sizes and electrode configurations. For example, the force sensor may comprise a matrix of 48×90 electrodes, and having a size of about 240 mm by 450 mm.

The electrodes of the second array may be arranged transverse to the electrodes of the first array and forms intersections where electrodes of the first array cross electrodes of the second array. Force sensitive resistive material is disposed between the first layer 230 and the second layer 240 at least some of the intersections, but preferably all intersections included within a contact-sensitive, or active area of the force sensor. In some embodiments, when no touch or contact is applied to the sensor 200, the electrodes of the first array 210 may be electrically isolated from the electrodes of the second array 220. In other words, the force sensor 200 provides an incomplete path for current when no contact is applied.

In other embodiments, electrodes of the first array 210 and the second array 220 may not be electrically isolated from one another, but may instead, at particular intersections, have some conductivity via the force sensitive material. Embodiments described herein may comprise intersections where electrodes of the first and second array are electrically isolated, and other intersections where electrodes of the first and second array are not electrically isolated. Preferably the first and second arrays are electrically isolated in the absence of a contact, in order to maximize signal to noise ratios, but this is not necessary and embodiments described herein are designed to work even without electrical isolation in a non-contact state.

When one or more contacts are applied to the sensor 200, the intersections proximate to the contacts may become electronically contacted if they are electronically isolated before the contacts are applied. As used herein, a contact is made on a surface when a measurable pressure is applied to the surface. For example, a contact may be applied by a finger, a stimuli, an object, or the like. Regardless of whether the electrodes were electrically isolated, the conductance or resistance at the intersections is a function of the force of the contacts.

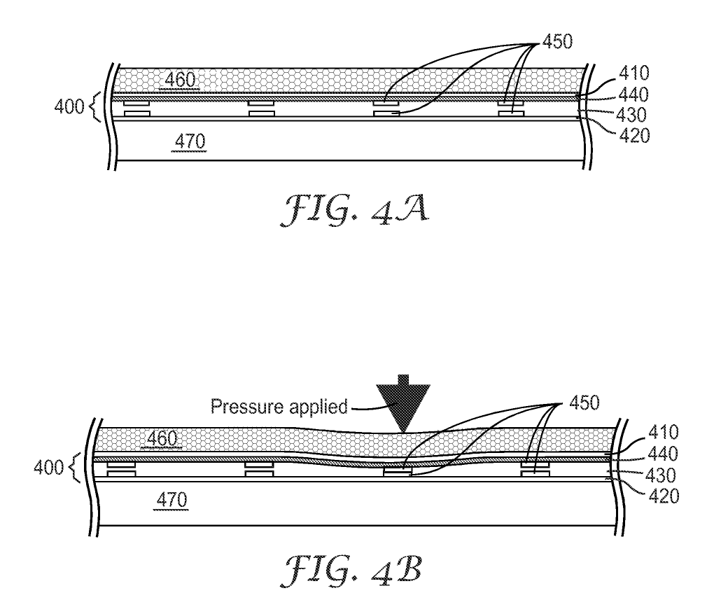

FIG. 3 illustrates a simplified schematic of a force sensitive device 300. In one embodiment, the force sensitive device 300 has a force sensor 310 and a control system 320. The force sensor 310 includes a first array of electrodes 330 and a second array of electrodes 340. The control system 320 has a signal source 350, a measurement circuit 360, and a processing unit 370. The signal source 350 is coupled to the first array of electrodes 330. In some cases, the signal source 350 is also coupled to the second array of electrodes 340. In some embodiments, the measurement circuit 360 is coupled to the second array of electrodes 340 via a passive interface.

As used herein, a passive interface comprises passive components, such as direct electrical connections, resistors, capacitors, switches, inductors, transformers, and other passive circuitry components. Compared with an interface that includes active components, such as transistor based amplifiers, a passive interface has no ability to generate power or amplify a signal, and as such may in some embodiments reduce cost of the circuit and power consumption of the circuit. Further, a passive interface may in some embodiments reduce heat generation of the circuit. This feature may be especially important for a force sensitive device having a large number of electrodes, for example, a matrix of 200×200 electrodes. This feature is also important for a battery-powered force sensitive device being used for an extended period of time, such as 8 hours or more per day.

In a particular embodiment, the electrodes of the first array are input electrodes, also referred as drive electrodes herein, which means that the electrodes are coupled to a signal source but not directly coupled to a measurement circuit. It may be observed that when electrodes of the first and second array are not electrically isolated (as for example with a contact made in proximity to a given intersection, or even in some non-contact states), the drive electrodes are coupled to the measurement circuit of the second array of electrodes. However, this coupling is indirect, i.e. only via the force sensitive material. Thus, as used here, the term “directly coupled” means coupled other than through the force sensitive material. Therefore, the control system 320 applies signals to the first array of electrodes 330, which are not themselves directly coupled to measurements circuits.

Typically, the measurement circuit includes analog multiplexers and analog-to-digital convertors to generate digital signals based upon output signals occurring on the electrodes. In one particular embodiment, the measurement circuit 360 only needs to provide analog multiplexers and analog-to-digital convertors to the second array of electrodes 340 but not the first array of electrodes 330. Consequently, as compared with a device that includes measurement circuits directly coupled to both the first array of electrodes and the second array of electrodes, the number of analog multiplexers and analog-to-digital convertors in such an embodiment is reduced and the cost of the system is also reduced. In a preferred embodiment, the measurement circuit 360 is designed using voltage-dividing principle. Methods and circuitry for measurement and determining force and position information related to one or more contacts are discussed in further detail herein.

Referring back to FIG. 2, in some cases, the electrodes of the force sensor 200 may be relatively narrow and inconspicuous to a user. In some other cases, the electrodes may be wide and obtrusive. In some embodiments, each electrode can be designed to have variable widths, e.g., an increased width in the form of a diamond- or other-shaped pad in the vicinity of the intersections between the first array of electrodes 210 and the second array of electrodes 220 in order to increase the contact area and thereby increase the effect of a contact on resistance changes at the intersections. Electrodes may be composed of, for example, indium tin oxide (ITO), copper, silver, gold, conductive polymer film, or any other suitable electrically conductive materials. The conductive materials may be in the form of wire, micro-wires, or a conductive layer.

In some embodiments, the input electrodes in the first array are substantially straight and substantially parallel to one another. In some embodiments, the electrodes in the second array are substantially straight and substantially parallel to one another. In preferred embodiments, the input electrodes of the first array are substantially perpendicular to the electrodes of the second array. In some cases, the first array of input electrodes and the second array of electrodes may be arranged diagonally. In some other cases, one or more electrodes of the first array or the second array may be in the form of curve lines, for example, to fit to the shape of a specific detecting area. In some embodiments, the electrodes of the first or second array may be in substantially circular form and the electrodes of the other array may be arranged in radial directions.

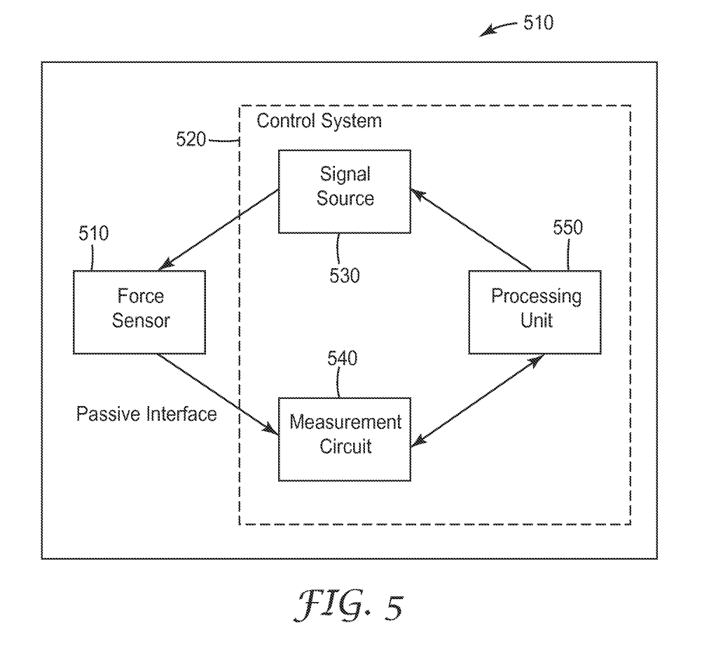

FIG. 4A is a cross-sectional view of an exemplary force sensor 400. In one embodiment, the force sensor 400 comprises a top sensor sheet 410, a bottom sensor sheet 420, and a space 430 between the top sensor sheet 410 and the bottom sensor sheet 420. The top sensor sheet 410 has electrodes (i.e. conductors) 440 arranged orthogonally with electrodes (not shown in FIG. 4A) on the bottom sensor sheet 420. In some embodiments, force sensitive resistive material 450 is applied on the electrodes proximate to the intersections where the electrodes on the top sensor sheet 410 cross the electrodes on the bottom sensor sheet 420, as illustrated in FIG. 4A. In some other embodiments, force sensitive resistive material is disposed in the space 430. In some cases, force sensitive resistive material may be applied to a surface of one of the sensor sheets, which faces to the other sensor sheet. Force sensitive resistive material may be applied to the surfaces of the top sensor sheet 410 and the bottom sensor sheet 420 that are facing each other. Force sensitive resistive material may be, for example, force sensitive resistors, pressure sensitive film (PSM), and the like. One type of conductive force transducers is described in further detail in U.S. Pat. No. 5,302,936, entitled “Conductive Particulate Force Transducer”.

In some embodiments, the force sensor 400 lays beneath a cover layer 460 that provides protection to the sensor. For example, the cover layer 460 may be a thin flexible sheet of acrylic or cover glass, a flexible display, a plastic film, a durable coating, or the like. In some other embodiments, the force sensor 400 is supported by a substrate 470.

FIG. 4B is a cross-sectional view of the exemplary force sensor 400 with pressure applied. The cover layer 460 and the top sensor sheet 410 bend in the pressure area. When pressure is applied, resistance between electrodes on the top sensor sheet and electrodes on the bottom sensor sheet varies commensurate with the pressure magnitude, providing signals responsive to such contact. The signals vary with the pressure applied to the sensor because the resistance values are changed in response to the magnitude of the pressure.

The exemplary embodiments show the sensor as a two layer of matrix electrodes with force sensitive resistive material sandwiched between the layers. An alternative sensor construction known in the art comprises two sets of electrodes (i.e. the first set and the second set) on a single layer, with force sensitive resistive material on a second layer. The first set of electrodes is electronically isolated from the second set of electrodes while the electrodes of the first set are adjacent to the electrodes of the second set individually. In some embodiments, pressure brings the sensitive resistive material in contact with two adjacent electrodes, one electrode of the first set and one electrode of the second set, and thus resistive contact is made laterally between two electrodes.

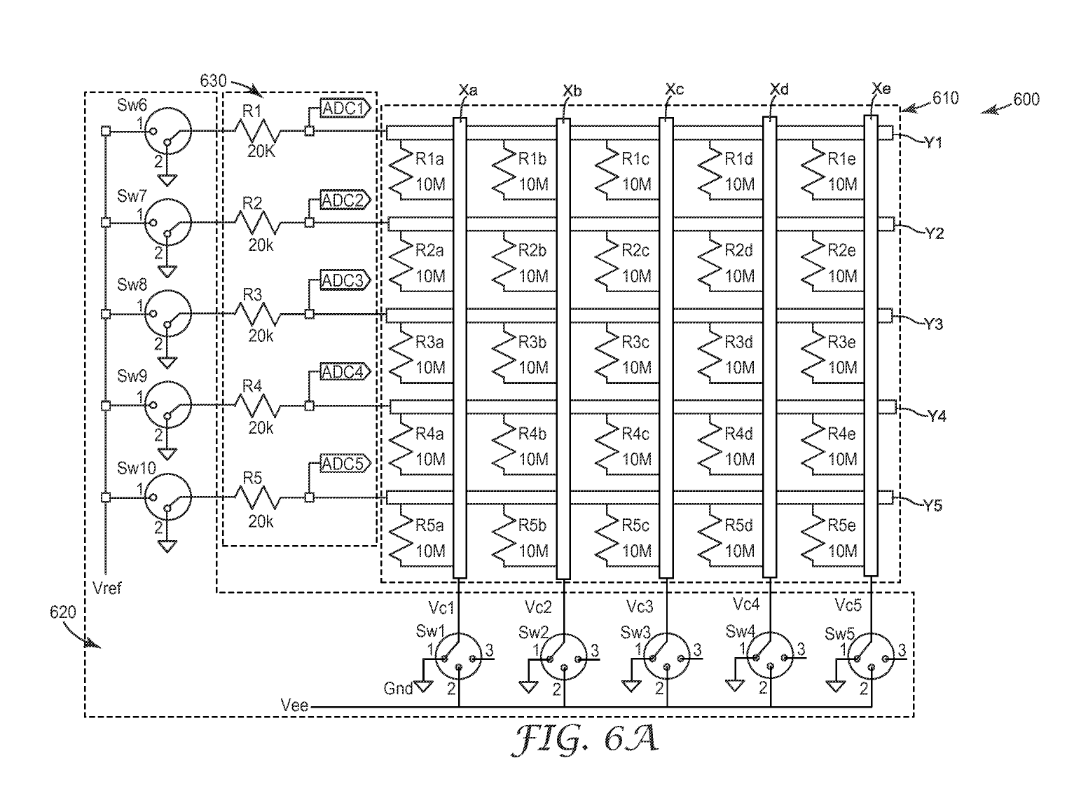

FIG. 5 illustrates a modular diagram of an embodiment of a force sensitive device 500. The force sensitive device 500 comprises a force sensor 510 and a control system 520. The control system 520 comprises a signal source 530, a measurement circuit 540, and a processing unit 550. As illustrated in FIG. 5, the signal source 530 provides drive signals to the force sensor 510. In some embodiments, the signal source 530 comprises a voltage source. In some other embodiments, the signal source 530 comprises a current source. In some cases, the signal source 530 may comprise more than one voltage sources. In some other cases, the signal source 530 may comprise one or more voltage sources and/or one or more current sources. As used herein, a drive signal may be a voltage or a current. In a particular embodiment, the signal source comprises one or more tri-state logic circuits that have three states: a high-signal state, a low-signal state, and a high-impedance state. For example, tri-state logic circuits have a low-impedance high-voltage state, a low-impedance low-voltage state, and a high-impedance state. In some embodiments, the signal source comprises one or more logic circuits that have two states: a high-signal state and a low-signal state. In some other embodiments, the signal source comprises one or more current sources that have two states: a high-impedance current-sourcing state and a high-impedance no-current state.

The measurement circuit 540 is configured to measure signals output from the force sensor 510. In a preferred embodiment, the measurement circuit 540 is configured to measure voltage signals. The interface between the measurement circuit 540 and the force sensor 510 is a passive interface. The processing unit 550 may comprise one or more microprocessors, digital signal processors, processors, Programmable Interface Controllers (PICs), microcontrollers, or any other form of computing unit. In some embodiments, the processing unit 550 includes on-chip analog-to-digital converters (ADCs), and these analog-to-digital converters may be used as part of the measurement circuit 540. In some other embodiments, the measurement circuit includes analog-to-digital converters external to the processing unit 550. In a particular embodiment, the ADCs convert analog voltage to digital signals.

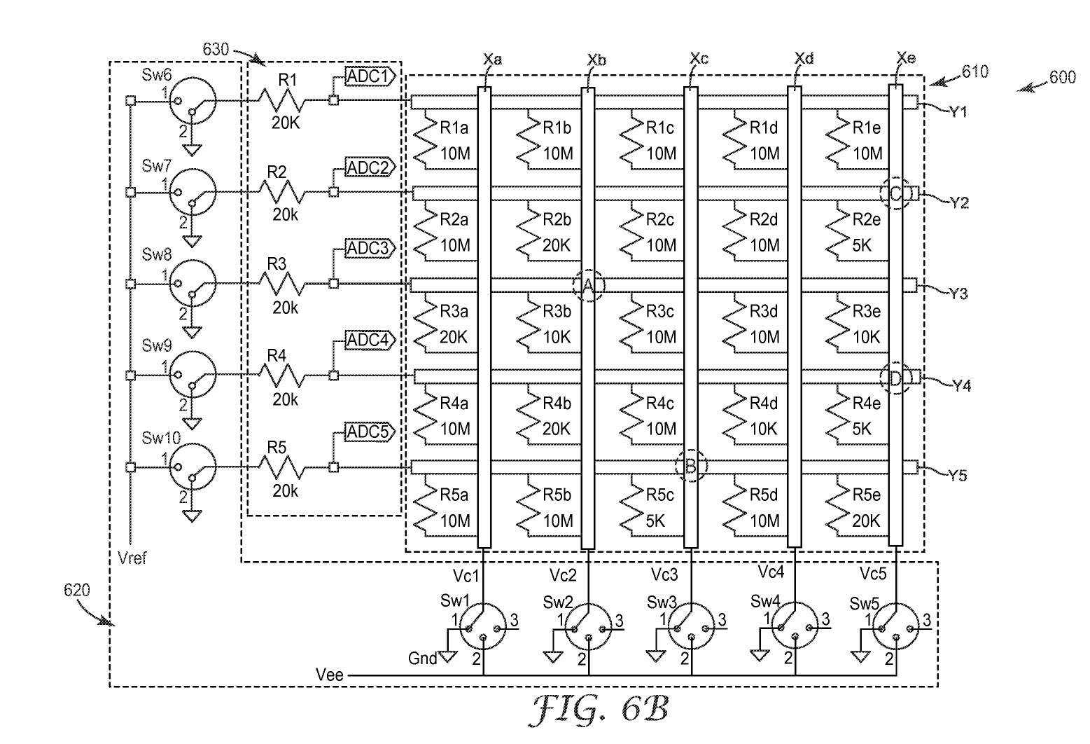

FIG. 6A illustrates a simulated circuitry of a control system for an exemplary force sensitive device 600. The force sensitive device 600 comprises a force sensor 610, a signal source 620, a measurement circuit 630, and a processing unit (not shown in FIG. 6A). The force sensor 610 comprises, for example, five column electrodes, Xa, Xb, Xc, Xd, and Xe, and five row electrodes, Y1, Y2, Y3, Y4, and Y5. In one embodiment, the force sensor 610 comprises force sensitive resistive material disposed at intersections of row electrodes and column electrodes, which is referred as inter-electrode resistors R_{FSR}. An intersection between electrode Ym (i.e. Y1, Y2, etc.) and electrode Xn (i.e. Xa, Xb, etc.) is referred as Imn herein. The resistance value of an inter-electrode resistor R_{FSR} at an intersection Imn, also referred to as resistance value at the intersection Imn herein, is denoted as Rmn. For example, the inter-electrode resistance at the intersection between Y2 and Xc is denoted as R2c. Similarly, the conductance value of an inter-electrode resistor R_{FSR} at an intersection Imn, also referred to as conductance value at the intersection Imn herein, is denoted as Gmn. For example, the inter-electrode conductance at the intersection I2c is denoted as G2c.

Resistance R is discussed in unit of ohm (Ω), kilo-ohm (KΩ), or mega-ohm (MΩ) herein. Conductance G is discussed in unit of mho (i.e. Siemens (S)) or millisiemens (mS) herein, where R=1/G. When no force is applied, the resistance value of an inter-electrode resistor R_{FSR} may be nearly infinite, which may be simulated as 10 MΩ. In one embodiment, row electrodes are coupled with the measurement circuit 630. The interface from the row electrodes to the measurement circuit 630 is passive. In an exemplary embodiment, the passive interface comprises direction connections. In some cases, the measurement circuit 630 comprises resistors. For example, each row electrode is coupled to a reference resistor, also referred as pull-up resistor herein. The reference resistors are illustrated as R1, R2, R3, R4, and R5 in FIG. 6A. In some embodiments, the reference resistors may have resistance values similar to the resistance values caused by contacts on the force sensor 610.

In some embodiments, the row electrodes may be coupled with the signal source 620, which provides a source signal, for example, a drive signal (i.e. high signal) or a reference signal (i.e. low signal), to the row electrodes through reference resistors. In an exemplary embodiment, the signal source 620 comprises a power source Vref (i.e. a direct current (DC) source) and several switches (i.e. Sw6, Sw7, . . . Sw10). As illustrated in FIG. 6A, Sw6 can be switched to position 1 to provide a drive signal (i.e. Vref) to electrode Y1 and to position 2 to provide a reference signal to electrode Y1. In one embodiment, the reference signal is a reference voltage and the drive signal is a logic high voltage. In a particular embodiment, the reference signal is a ground voltage. As used herein, a ground voltage refers to a local common voltage that may be connected to earth ground (0 volts) or a local ground reference, for example, a reference in a battery powered device that is not at 0 volts.

In some embodiments, the column electrodes are input electrodes coupled with the signal source 620. As illustrated in FIG. 6A, input electrodes are not coupled with the measurement circuit 630. In some cases, the signal source may comprise tri-state logic circuits to provide a drive signal, a reference signal, or high impedance. For example, tri-state logic circuits may comprise tri-state switches, illustrated as Vee combined with Sw1, Sw2, Sw3, Sw4, and Sw5 in FIG. 6A. In this example, the column electrode Xa is connected to a ground voltage when the switch Sw1 is switched to position 1; Xa is connected to a logic high voltage Vee when Sw1 is switched to position 2; and Xa is electronically isolated from ground when Sw1 is switched to position 3.

FIG. 6B illustrates the exemplary force sensitive device 600 with contacts imposed. As shown in FIG. 6B, the sensor 610 is pressed at points A, B, C, and D. Each contact on the sensor may cause conductance or resistance changes to one or more inter-electrode resistors R_{FSR} proximate to the pressure point. For example, because of the contact at point A, the inter-electrode resistor R3b between electrodes Xb and Y3 is changed to 10 KΩ. The contact at point A has also caused additional resistance changes at three adjacent inter-electrode resistors, R3a, R2b, and R4b. The relative or absolute resistance or conductance values are determined based upon the signals received by the measurement circuit 630. Methods for determining resistance or conductance values related to one or more contacts are discussed in further detail herein.

FIG. 6C illustrates another simulated circuitry of a control system for an exemplary force sensitive device 600C. The force sensitive device 600C comprises a force sensor 610C, a signal source 620C, a measurement circuit 630C, and a processing unit (not shown in FIG. 6C). The signal source 620C comprises current sources (i.e. I_{ref1}, I_{ref2}, . . . I_{ref5}), a voltage source (i.e. Vee), and switches (i.e. Sw1, Sw2, . . . Sw10). The current sources can be turned on and off. The measurement circuit 630C comprises analog-to-digital converters (i.e. ADC1, ADC2, . . . , ADC5), and optionally reference resistors (i.e. R1, R2, . . . R5). In such configuration, reference resistors are not necessary or reference resistors can be arbitrarily small. The force sensor 610C comprises row electrodes (i.e. Y1, Y2, . . . Y5) and column electrodes (i.e. Xa, Xb, . . . Xe), where row electrodes cross column electrodes with a gap at the electrode intersections. Force sensitive material is disposed at least some of the gaps at the electrode intersections.

In some embodiments, drive signals applied to column electrodes may be different from drive signals applied to row electrodes. For example, the voltage source Vref illustrated in FIG. 6A may be higher than the voltage source Vee. As another example, as illustrated in FIG. 6C, drive signals applied to column electrode may be voltage signals while drive signals applied to row electrodes may be current signals.

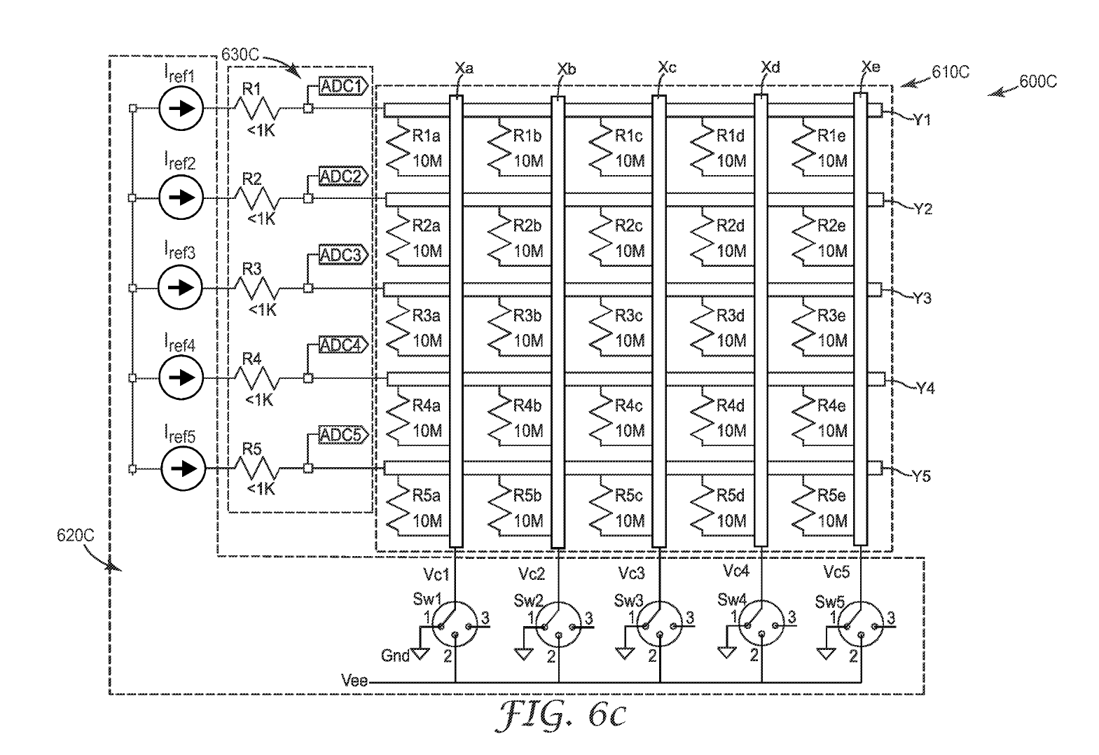

In one embodiment, based upon the resistance values computed, the location information of a contact may be determined by selecting an intersection that has a local minimum resistance (or local maximum conductance) among adjacent inter-electrode resistors. In another embodiment, resistance values (i.e. relative resistance values or absolute resistance values) or conductance values (i.e. relative conductance values or absolute conductance values) of these adjacent inter-electrode resistors may be used to determine the location information of a contact by applying known interpolation techniques. In yet another embodiment, force magnitude of a contact may be determined based upon the absolute resistance value of an inter-electrode resistor, for example, using a graph illustrated in FIG. 7.

Contact Information Determination Approach I

In one embodiment, a force sensitive system may comprise a force sensor, a signal source, a measurement circuit, and a processing unit. The force sensor may comprise a first array (i.e. X array) of input electrodes, a second array (i.e. Y array) of electrodes, and force sensitive resistive material disposed between the electrodes of the first array and the second array. The first array of input electrodes is not coupled to the measurement circuit. The signal source is coupled to the first array of electrodes and configured to provide drive signals and reference signals to one or more electrodes. The measurement circuit is coupled to the second array of electrodes and configured to measure voltage signals thereon and the interface between the measurement circuit and the second array of electrodes is passive. The processing unit is configured to determine location information related to a contact on the force sensitive sensor based upon the signals received by the measurement circuit. In one embodiment, the signal source provides a drive signal to at least one input electrode of the first array at a time and the measurement circuit receives first receive signals on the second array of electrodes. The first receive signals is responsive to the first drive signal. The location information may be developed based upon the receive signals received by the measurement circuit.

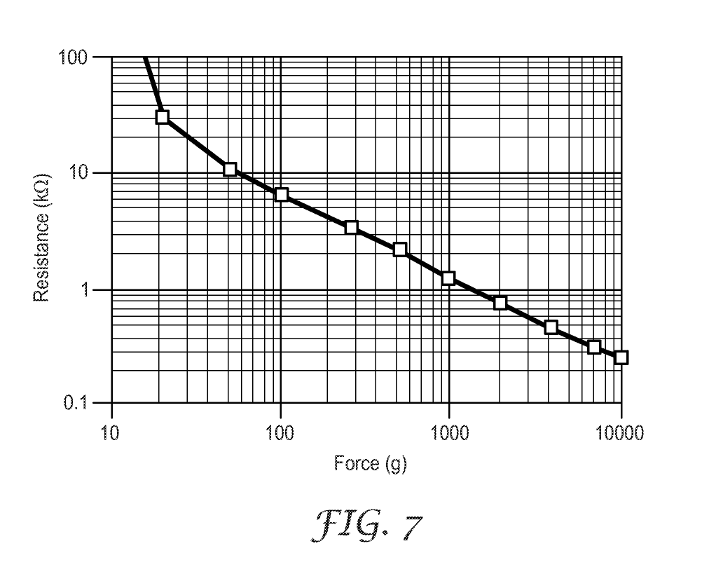

FIG. 8 illustrates a flowchart of an embodiment of a method for determining force and position information related to one or more contacts on a force sensor in a force sensitive system. First, the signal source applies a reference signal to a second array of electrodes (step 810). The reference signal may be a ground voltage, for example. Next, the signal source applies a drive signal to at least one input electrode of the first array (step 820) and a reference signal to the other electrodes of the first array (step 830). An output signal, referred as a receive signal herein, is received at each electrode of the second array by the measurement circuit (step 840). A drive signal is applied to at least one input electrode of the first array at a time, until all electrodes of the first array have been applied to a drive signal (step 850). In some embodiments, at least a plurality of electrodes, not all electrodes, of the first array, is applied to a drive signal. Then, a signal divider ratio is computed at each intersection of electrodes (step 860).

Relative conductance (or resistance) values at intersections are determined based upon the signal divider ratio (step 870). Position and force information of one or more contacts may be determined based upon relative conductance values at electrode intersections (step 880). Relative conductance (or resistance) values are sufficient to calculate position information of contacts. In some embodiments, interpolation approaches may be applied to the relative conductance (or resistance) values to derive more precise location information. Absolute values of FSR resistances may also be calculated, if needed to determine absolute values of contacts' force.

Referring to the exemplary sensor 610 implemented on a simulated circuitry in FIG. 6B, four contacts are imposed on the sensor 610. The sensor 610, as an example, comprises five Y array electrodes and five X array electrodes. Below are exemplary steps for taking measurements following the flowchart in FIG. 8.

Step 1: Sw6-Swl0 are switched to position 2 so that electrodes Y1-Y5 are connected to a ground reference voltage (Gnd);

Step 2: Sw1 is switched to position 2 so that the electrode Xa is connected to a logic high voltage (Vee); the switches for the other X array electrodes (Sw2, Sw3, Sw4, Sw5) are switched to position 1 so that electrodes Xb, Xc, Xd, and Xe are connected to Gnd respectively.

Step 2a: Measure signals on Y array electrodes by analog-to-digital convertors (ADC1-ADC5) and the measurement results are denoted as V_{ADC1}, V_{ADC2}, V_{ADC2}, V_{ADC3}, V_{ADC4}, and V_{ADC5}.

Step 3: Sw2 is switched to position 2 so that the electrode Xb is connected to Vee; Sw1, Sw3, Sw4, Sw5 connect electrodes Xa, Xc, Xd, and Xe to Gnd respectively.

Step 3a: Measure V_{ADC1}-V_{ADC5}.

Step 4: Sw3 is switched to position 2 so that the electrode Xc is connected to Vee; Sw1, Sw2, Sw4, Sw5 connect electrodes Xa, Xb, Xd, and Xe to Gnd respectively.

Step 4a: Measure V_{ADC1}-V_{ADC5}.

Step 5: Sw4 is switched to position 2 so that the electrode Xd is connected to Vee; Sw1, Sw2, Sw3, Sw5 connect electrodes Xa, Xb, Xc, and Xe to Gnd respectively.

Step 5a: Measure V_{ADC1}-V_{ADC5}.

Step 6: Sw5 is switched to position 2 so that the electrode Xe is connected to Vee; Sw1, Sw2, Sw3, Sw4 connect electrodes Xa, Xb, Xc, and Xd to Gnd respectively.

Step 6a: Measure V_{ADC1}-V_{ADC5}.

Measurement results for the exemplary sensor 610 are illustrated in Table 1, where Vee is 3V.

TABLE 1
ADC Measurements (Volts)

| V_{ADC} | a | b | c | d | e |
|---|---|---|---|---|---|
| 1 | 0.001 | 0.001 | 0.001 | 0.001 | 0.001 |
| 2 | 0.001 | 0.5 | 0.001 | 0.001 | 2 |
| 3 | 0.5 | 1 | 0.001 | 0.001 | 1 |
| 4 | 0.001 | 0.375 | 0.001 | 0.75 | 1.5 |
| 5 | 0.001 | 0.001 | 2 | 0.001 | 0.5 |

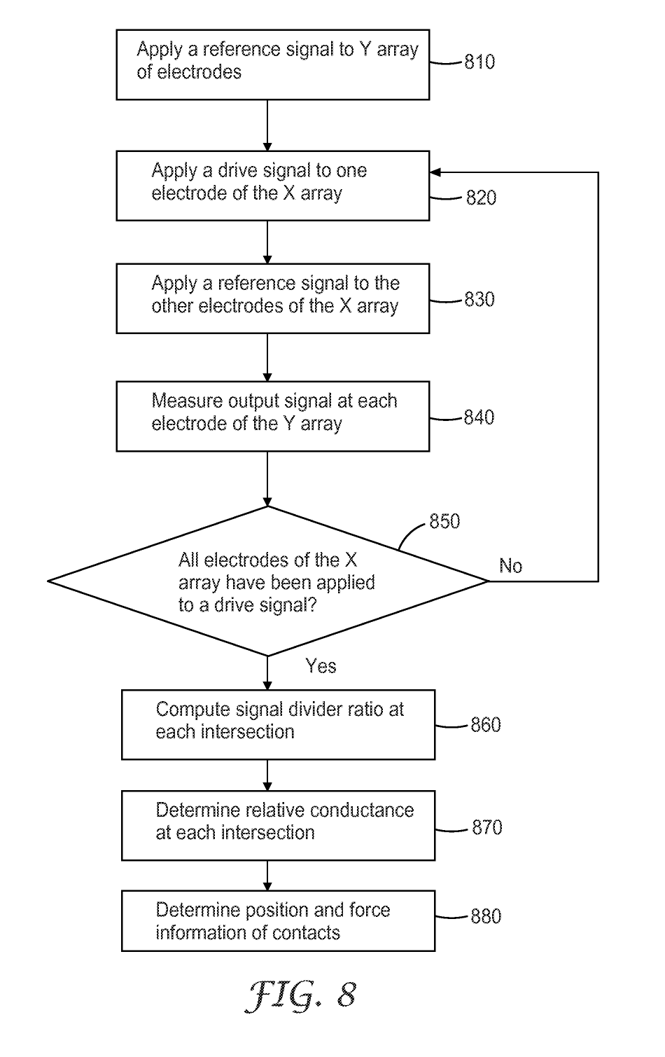

FIG. 9 shows an exemplary circuit 900 at an electrode intersection as specified in the steps above, such that one electrode of X array is connected to Vee and the other electrodes of X array are connected to ground voltage. R_{FSR} represents an inter-electrode resistor, which is the resistor provided by the force sensitive resistive material at an electrode intersection. One end of R_{FSR} is connected to an analog-to-digital converter (ADCm) for measurement of voltage V_{ADCm}. The other end of R_{FSR} is connected to a logic high voltage Vee. The voltages measured on channels ADC1-ADC5 will be the result of a conductance divider function with detail described below herein.

As an X electrode is driven to Vee, a measurable current will be conducted to a Y electrode if the inter-electrode resistor R_{FSR} has resistance value less than a threshold level. If there is no contact or very low contact force approximate to an intersection, R_{FSR} will typically be very high and negligible voltage will be measured at ADCm.

In one embodiment, the reference resistor Rm has conductance Gm. The inter-electrode resistor at intersection Imn (i.e. the intersection between electrode Ym and electrode Xn) has resistance value Rmn and conductance value Gmn. If no contact is made approximate the intersection between Ym and Xn, Gmn will be close to 0. The conductance of the electrode Ym is denoted as G(Ym), which depends on the number of contacts and the amount of force of each contract approximate to Ym. G(Ym) is the summation of conductance of all inter-electrode resistors on an electrode Ym. For example, for the sensor 610, G(Ym) includes the parallel combination (sum) of the five inter-electrode resistors' conductance values. That is, G(Ym)=Gma+Gmb+Gmc+Gmd+Gme, where Gmn is the conductance value of the inter-electrode resistor at the intersection between Xn (i.e. Xa, Xb, . . . Xe) and Ym. When a high signal Vee is applied to the electrode Xn, the voltage V_{ADCm} measured at ADCm will be:

V_{ADCm}=Vee×Gmn/(Gm+G(Ym)), Equation 1

where G(Ym) is the total inter-electrode conductance of the electrode Ym, Vee is the drive voltage, Gmn is the conductance value of the inter-electrode resistor at the intersection of electrode Ym and Xn, and Gm is the conductance value of the reference resistor Rm. The sum of the conductance of the electrode Ym and the conductance of the reference resistor Rm may be referred as the conductance from Ym to ground herein. Here, G(Ym) is unknown. Equation 1 indicates that output signal measured as V_{ADCm} at a Y electrode Ym is proportional to the ratio of the conductance at intersection Gmn over the sum of the conductance value of the electrode Ym and the conductance value of the reference resistor Rm.

Equation 2 may be used to calculate the ratio of V_{ADCm} to the drive signal Vee, which is proportional to relative conductance value of Gmn, expressed as a percentage:

Gmn %=100%×V_{ADCm}/Vee Equation 2

where Gmn % is the relative conductance value of Gmn. Gmn %=Gmn/(Gm+G(Ym)), is the conductance value Gmn relative to the sum of the conductance of the electrode Ym plus the conductance of the reference resistor Rm, which may be referred as the conductance from Ym to ground. Table 2 shows the results of applying Equation 2 to the measurements from Table 1.

TABLE 2
Relative Conductance in Percentage

| ADC | a | b | c | d | e | Rm |
|---|---|---|---|---|---|---|
| 1 | 0.03% | 0.03% | 0.03% | 0.03% | 0.03% | 99.83% |
| 2 | 0.03% | 16.67% | 0.03% | 0.03% | 66.67% | 16.57% |
| 3 | 16.67% | 33.33% | 0.03% | 0.03% | 33.33% | 16.60% |
| 4 | 0.03% | 12.50% | 0.03% | 25.00% | 50.00% | 12.43% |
| 5 | 0.03% | 0.03% | 66.67% | 0.03% | 16.67% | 16.57% |

The relative conductance values in Table 2 indicate the relative conductance among the inter-electrode resistors on each Y array electrode. For example, G3b (33.3%) is 2 times of G2b (16.7%). Additionally, the percentage in each cell represents conductance contribution of each inter-electrode resistor to the conductance of the corresponding Y array electrode to ground. For example, G3b represents that the inter-electrode resistor at intersection I3b contributes to 33.3% of the overall conductance of the electrode Ym to ground.

The results in Table 2 show good accuracy in conductance ratios of inter-electrode resistors on any given Y array electrode but less accuracy in conductance ratios from one Y electrode to another. For example, G3a/G3b ratio is accurate, but G3b/G4b is less accurate.

Further, the sum of the relative conductance of the inter-electrode resistors on a Y array electrode Ym plus the relative conductance of the reference resistor Rm connected to Ym should be 100%. Therefore, the relative conductance of the reference resistor Rm can be computed using Equation 3.

Gm %=100%−G(Ym)%, Equation 3

where Gm %=relative conductance of the reference resistor Rm relative to the conductance between electrode Ym and ground, and G(Ym) % is the summation of Gmn % of the intersections on the electrode Ym. The results of applying Equation 3, as an example, are shown in Table 2 column ‘Rm’.

In one embodiment, the position information of one or more touches is determined based upon the relative conductance computed by Equation 2. In a particular embodiment, the position information of one or more contacts is determined by finding the intersection having a local maximum relative conductance value among the relative conductance values of adjacent intersections. For example, the relative conductance G3b in Table 2 is a local maximum of relative conductance values of adjacent intersections, so the intersection between Xb and Y3 is determined as a contact position. Further details for determining contact position based upon signal magnitudes may be found in, for example, US Patent Application No. 20090284495, entitled “Systems and Methods for Assessing Locations of Multiple Touch Inputs”. The entire contents of these disclosures are incorporated herein by reference.

In some embodiments, absolute conductance value of each inter-electrode resistor may be calculated using the values computed from Equation 2 and Equation 3. Given that reference resistor Rm has a known conductance, and its relative conductance in terms of percentage is known from Equation 3 (shown in Table 2 as an example), the absolute conductance value of each inter-electrode resistor on an electrode Ym can be calculated by Equation 4.

Gmn=Gm×Gmn %/Gm % Equation 4

where Gmn is the conductance value of the inter-electrode resistor at intersection Imn, Gmn % is the relative conductance value of Gmn, Gm is the conductance value of the reference resistor Rm, Gm % is the relative conductance value of Gm.

Absolute conductance values calculated for the exemplary sensor 610 using Equation 4 are shown in Table 3, and corresponding resistance values are shown in Table 4.

TABLE 3
Conductance Values in mS (mili-mhos)

| ADC | a | b | c | d | e | Rm |
|---|---|---|---|---|---|---|
| 1 | 0.00002 | 0.00002 | 0.00002 | 0.00002 | 0.00002 | 0.05 |
| 2 | 0.00010 | 0.05030 | 0.00010 | 0.00010 | 0.20121 | 0.05 |
| 3 | 0.05020 | 0.10040 | 0.00010 | 0.00010 | 0.10040 | 0.05 |
| 4 | 0.00013 | 0.05027 | 0.00013 | 0.10054 | 0.20107 | 0.05 |
| 5 | 0.00010 | 0.00010 | 0.20121 | 0.00010 | 0.05030 | 0.05 |

TABLE 4
Resistance Values in kΩ

| ADC | a | b | c | d | e | Rm |
|---|---|---|---|---|---|---|
| 1 | 59900 | 59900 | 59900 | 59900 | 59900 | 20 |
| 2 | 9940 | 20 | 9940 | 9940 | 5 | 20 |
| 3 | 20 | 10 | 9960 | 9960 | 10 | 20 |
| 4 | 7460 | 20 | 7460 | 10 | 5 | 20 |
| 5 | 9940 | 9940 | 5 | 9940 | 20 | 20 |

Values in Table 3 may also be used to find local maxima, and thus to locate contact points. Interpolation may also be performed among the values to increase resolution. The absolute resistance values of the inter-electrode resistors may be used to determine force magnitude of the one or more contacts applied to the force sensor, for example, using a resistance vs. force magnitude graph illustrated in FIG. 7.

Contact Information Determination Approach II

In one embodiment, the force sensor may comprise a first array (i.e. X array) of input electrodes on a first layer, a second array (i.e. Y array) of electrodes on a second layer, the second array of electrodes arranged transverse to the first array of electrodes to form intersections where electrodes of the first array cross electrodes of the second array, and force sensitive resistive material disposed between the first layer and the second layer at least some of intersections. The first array of input electrodes is not coupled to the measurement circuit. The force sensitive system may comprise a force sensor, a signal source, a measurement circuit, and a processing unit. The signal source is coupled to the first array of electrodes and configured to provide a drive signal to one or more electrodes. The measurement circuit is coupled to the second array of electrodes and configured to measure signals thereon and the interface between the measurement circuit and the second array of electrodes is passive. The processing unit is configured to determine location information related to a contact on the force sensitive sensor based upon the signals received by the measurement circuit. In one embodiment, the signal source provides a drive signal to electrodes of the second array. The signal source provides high impedance to the input electrodes of the first array one at a time. The measurement circuit receives receive signals on the second array of electrodes. The location information is developed based upon the second receive signals received by the measurement circuit.

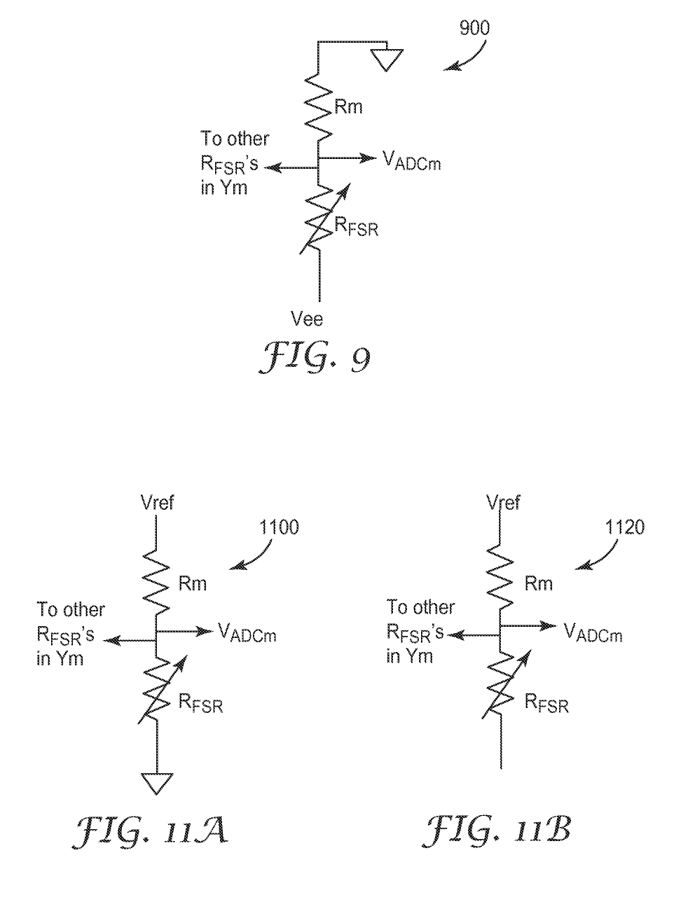

FIG. 10 illustrates a flowchart of an exemplary embodiment of a method for determining force and position information related to one or more contacts on a force sensor in a force sensitive system. First, the signal source applies a drive signal to the Y array of electrodes (step 1010). The signal source applies a reference signal to X array of electrodes (step 1015). The reference signal may be a ground voltage, for example. Next, a first set of output signals at each electrode of the Y array is measured by the measurement circuit as a baseline (step 1020). Then, the signal source applies high impedance to at least one input electrode of the X array (step 1025) and a reference signal to the other electrodes of the X array (step 1030). A second set of output signals is received at each electrode of the Y array by the measurement circuit (step 1040) and added to a matrix of output signals. When high impedance is applied to an electrode, the electrode is electronically isolated with the other electrodes in the same array. At least one input electrode of the X array is applied to high impedance at a time, until all electrodes of the first array have been applied to high impedance (step 1050). In some embodiments, at least a plurality of electrodes, not all electrodes, of the first array is applied to high impedance in this step.

Further, output signal change ratio at electrode intersections are computed based upon the first and second set of output signals (step 1060). Relative conductance (or resistance) values of inter-electrode resistors are determined based upon the signal change ratio (step 1070). Position and force information of one or more contacts may be determined based upon relative conductance values (step 1080). Relative conductance (or resistance) values are sufficient to calculate position information of contacts. In some embodiments, relative values can be used in interpolation calculations to derive more precise position information. Absolute conductance (or resistance) values of inter-electrode resistors may also be calculated, if needed, to determine force magnitude of contacts.

Referring back to the exemplary sensor 610 in FIG. 6B, four contacts are imposed on the sensor 610. The sensor 610, as an example, comprises five Y array electrodes and five X array electrodes. Below are exemplary measurement steps for Approach II on the sensor 610.

Measurement 1—Measure conductance values of Y array electrodes:

Step 11: Sw6-Sw10 are switched to position 1 so that electrodes Y1-Y5 are connected through reference resistors to Vref; Sw1, Sw2, Sw3, Sw4, Sw5 are switched to position 1 so that electrodes Xa, Xb, Xc, Xd, and Xe are connected to ground respectively.

Step 11a: Measure signals on Y array electrodes by analog-to-digital convertors (ADC1-ADC5) and the measurement results are denoted as V1_{ADC1}, V1_{ADC2}, V1_{ADC2}, V1_{ADC3}, V1_{ADC4}, and V1_{ADC5}.

Measurement results for the exemplary sensor 610 are shown in Table 5, where both Vref and Vee are 3V.

TABLE 5
Measurement 1

| V_{ADC} | Volts |
|---|---|
| 1 | 2.972 |
| 2 | 0.500 |
| 3 | 0.500 |
| 4 | 0.375 |
| 5 | 0.500 |

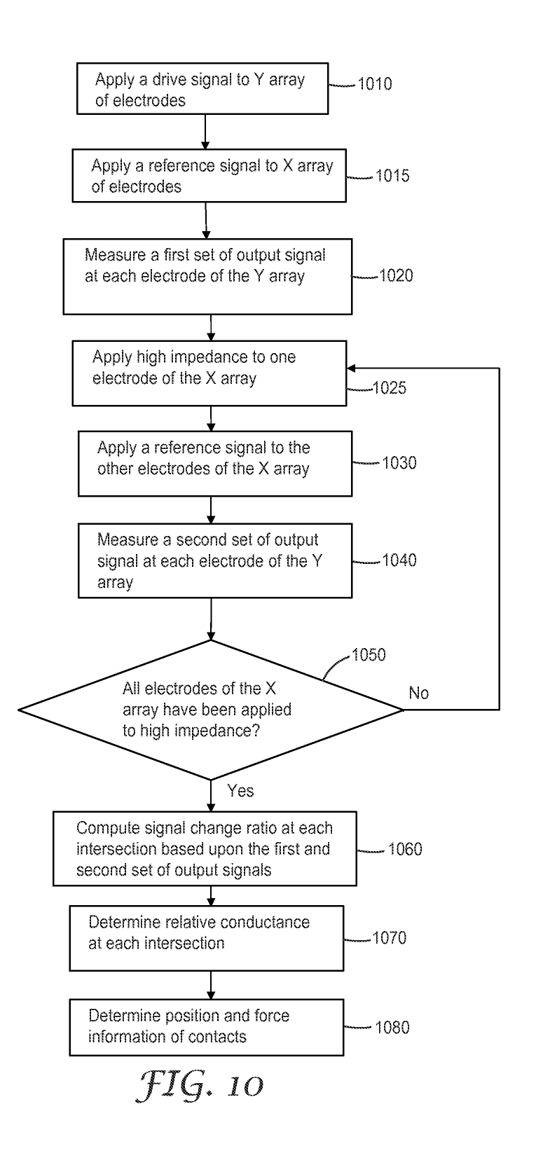

FIG. 11A shows an exemplary circuit 1110 at an electrode intersection as specified in the steps above, such that electrodes of Y array are connected though reference resistors to Vref and electrodes of X array are connected to ground. An inter-electrode resistor R_{FSR} represents the resistance provided by the force sensitive resistive material at an electrode intersection. One end of R_{FSR} is connected to an analog-to-digital converter (ADCm) to measure voltage V1_{ADCm}. The other end of R_{FSR} is connected to a ground voltage. The voltages measured on channels ADC1-ADC5 will be a function of conductance to ground from the X array electrode with detail described below herein.

V1_{ADCm} is a function of G(Ym), the inter-electrode conductance to ground from the Ym electrode, relative to Gm, the conductance value of the reference resistor Rm. Equation 5 shows the measured voltage V1_{ADCm} on electrode Ym:

V1_{ADCm}=Vref×Gm/(Gm+G(Ym)), Equation 5

where V1_{ADCm} is the measured voltage on electrode Ym, Vee is the drive voltage, Gm is the conductance of the reference resistor Rm, and G(Ym) is the inter-electrode conductance of the electrode Ym. Measurement 1 provides a baseline for measurement and computation below.

Measurement 2—Y array electrodes conductance ratios:

In Measurement 2, measurements are made with an electrode of X array isolated from ground one at a time.

Step 21: Sw6-Swl0 are switched to position 1 so that electrodes Y1-Y5 are connected through reference resistors to Vref;

Step 22: Sw1 is switched to position 3 so that the electrode Xa is electronically isolated from ground; the other switches for X array electrodes (Sw2, Sw3, Sw4, Sw5) are switched to position 1 so that electrodes Xb, Xc, Xd, and Xe are connected to Gnd respectively.

Step 22a: Measure signals on Y array electrodes by analog-to-digital convertors (ADC1-ADC5) and the measurement results are denoted as V2_{ADC1}, V2_{ADC2}, V2_{ADC2}, V2_{ADC3}, V2_{ADC4}, and V2_{ADC5}.

Step 23: Sw2 is switched to position 3 so that the electrode Xb is electronically isolated from ground; Sw1, Sw3, Sw4, Sw5 connect electrodes Xa, Xc, Xd, and Xe to Gnd respectively.

Step 23a: Measure V_{ADC1}-V_{ADC5}.

Step 24: Sw3 is switched to position 3 so that the electrode Xc is electronically isolated from ground; Sw1, Sw2, Sw4, Sw5 connect electrodes Xa, Xb, Xd, and Xe to Gnd respectively.

Step 24a: Measure V2_{ADC1}-V2_{ADC5}.

Step 25: Sw4 is switched to position 3 so that the electrode Xd is electronically isolated from ground; Sw1, Sw2, Sw3, Sw5 connect electrodes Xa, Xb, Xc, and Xe to Gnd respectively.

Step 25a: Measure V2_{ADC1}-V2_{ADC5}.

Step 26: Sw5 is switched to position 3 so that the electrode Xe is electronically isolated from ground; Sw1, Sw2, Sw3, Sw4 connect electrodes Xa, Xb, Xc, and Xd to Gnd respectively.

Step 26a: Measure V2_{ADC1}-V2_{ADC5}.

Measurement results for the exemplary sensor 610 from the steps above are shown in Table 6, where column ‘n’ (i.e. ‘a’, ‘b’, etc.) contains measurement data of each ADC channel when the electrode Xn is electronically isolated and column ‘Measure. 1’ contains the measurement data from Measurement 1.

TABLE 6
Measurement 2 (Volts)

| ADC | a | b | c | d | e | Measure. 1 |
|---|---|---|---|---|---|---|
| 1 | 2.971 | 2.972 | 2.971 | 2.971 | 2.972 | 2.972 |
| 2 | 0.500 | 0.602 | 0.500 | 0.498 | 1.105 | 0.500 |
| 3 | 0.600 | 0.705 | 0.500 | 0.500 | 0.802 | 0.500 |
| 4 | 0.375 | 0.452 | 0.375 | 0.501 | 0.829 | 0.375 |
| 5 | 0.500 | 0.500 | 1.494 | 0.500 | 0.651 | 0.500 |

FIG. 11B shows an exemplary circuit 1120 at an electrode intersection as specified in the steps above, such that electrodes of Y array are connected through reference resistors to

Vref and one electrode of X array is isolated from ground. An inter-electrode resistor R_{FSR} represents the resistance provided by the force sensitive resistive material at an electrode intersection. One end of R_{FSR} is connected to an analog-to-digital converter (ADCm) to measure voltage V_{ADCm}. The other end of R_{FSR} is isolated from ground. As described above, measurements V2_{ADCm} received from Y array electrodes are repeated with a different X array electrode electrically isolated and the other electrodes of X array connected to ground.

If a contact applies approximate to an intersection, the inter-electrode resistor at the intersection may have conductance greater than a threshold level. When an electrode of X array is isolated, the inter-electrode resistor conductance will change its contribution to the corresponding Y array electrode conductance, so receive signals by the measurement circuit will change appreciably from receive signals of Measurement 1. If there is no contact approximate to an intersection, conductance of the inter-electrode resistor will be very low and the electrode changing from grounded to un-grounded will have negligible effect to the receive signals.

The changes to channel measurements indicate the relative conductance of electrode intersections on X array electrodes. The change of a channel measurement due to isolation can be calculated using Equation 6.

ΔV_{ADCmn}=100%×(V2_{ADCmn}−V1_{ADCm})/V1_{ADCm} Equation 6

where V1_{ADcm} is the voltage measurement on the electrode Ym of Measurement 1, V2_{ADcm} is the voltage measurement on the electrode Ym when the electrode Xn is electronically isolated from ground of Measurement 2, ΔV_{ADcm} is the measurement change due to isolation of the electrode Xn. The changes of channel measurements in percentage are illustrated in Table 7, based on the measurement results in Table 6, as an example.

TABLE 7
Percentage Changes between Measurement 1 & 2

| ADC | a | b | c | d | e |
|---|---|---|---|---|---|
| 1 | −0.03% | 0.00% | −0.03% | −0.03% | 0.00% |
| 2 | 0.04% | 20.50% | 0.08% | −0.32% | 121.10% |
| 3 | 20.13% | 41.14% | 0.04% | 0.02% | 60.54% |
| 4 | 0.02% | 20.53% | 0.08% | 33.49% | 121.04% |
| 5 | 0.04% | 0.04% | 199.03% | 0.03% | 30.27% |

The change in each channel measurement V_{ADCm} due to isolation of each electrode of X array in the force sensor is thus calculated. The changes of channel measurements indicate the relative conductance value of inter-electrode resistors on an X array electrode. For example, in Table 7 column ‘e’, the value of row 3 verse row 4 indicates the conductance ratio of the inter-electrode resistor at intersection I3e verse the inter-electrode resistor at intersection I4e. Specifically, the conductance ratio is about 0.5, which is 61%/121%. Location information of one or more contacts on the force sensor may be determined based upon the relative conductance values. In some embodiments, the location information of one or more contacts is determined by finding the intersection having a local maximum relative conductance value among the relative conductance values of adjacent intersections. For example, the relative conductance G3b in Table 7 is a local maximum of relative conductance values of adjacent intersections, so the intersection between Xb and Y3 is determined as a contact position.

In some cases, two inter-electrode resistors at adjacent intersections on an X array electrode having equal relative conductance values indicates a contact centered between the two intersections. In some other cases, a larger relative conductance value of an inter-electrode resistor at one intersection and a smaller relative conductance value of an inter-electrode resistor at an adjacent intersection indicate a contact closer to the intersection having larger conductance value. Interpolation may be used to refine the position of a contact. For example, based upon the measurement results in Table 7, contacts could be determined to approximate to intersections 13b, 15c, 12e, and 14e.

Both Approach I and Approach II illustrate measurement results using voltage sources. People skilled in the art should readily design similar measurement circuits using current sources. For example, the signal source may comprise “weak pullup” current sources in combination with standard logic gates or transistor based current sources in combination with logic switches.

While Approach I is sufficient to determine conductance in a force sensor, the resolution and accuracy may be enhanced by combining the Approach I with a second set of measurements and calculations described in Approach II. Approach II may enhance results, especially on sensors that measure multiple simultaneous conductance maxima and that have a larger number of electrodes, for example, 30 to 100 electrodes in one or both arrays in the sensor. In such cases, the conductance of reference resistors may be much larger than the conductance of inter-electrode resistors of Y electrodes. This in combination with measurement noise may reduce accuracy of location information and force magnitude.

Changes of channel measurements in Approach II indicate the relative conductance among the inter-electrode resistors on an electrode of X array. Approach II may provide better accuracy in conductance ratio of inter-electrode resistors on an X array electrode in comparison with Approach I. The relative conductance determined in Approach II could be used to adjust the computation results of Approach I in one of a number of approaches described further in details hereafter. In some alternative embodiments, the relative conductance determined in Approach I could be used to adjust the computation results of Approach II to obtain better accuracy in determining location information and pressure magnitude of one or more contacts.

In one embodiment, the inter-electrode conductance of electrode Ym, G(Ym), can be computed using Equation 5 as Gm and Vee are known.

G(Ym)=Vref/V1_{ADCm}×Gm−Gm, Equation 5′

where V1_{ADCm} is the measured voltage on electrode Ym of Measurement 1 of Approach II, Vee is the drive voltage, Gm is the conductance of the reference resistor Rm, and G(Ym) is the conductance of the electrode Ym. Thus, Gm % can be computed based on G(Ym) using Equation 7, instead of using Equation 3 in Approach I.

Gm %=100%×Gm/(Gm+G(Ym)), Equation 7

where Gm is the conductance of the reference resistor Rm, Gm % is the relative conductance value of Gm, and G(Ym) is the inter-electrode conductance of the electrode Ym. This value may be substituted into Equation 4 (Approach I) to calculate individual conductance value of each inter-electrode resistor on the electrode Ym.

For example, based on the simulated circuitry in FIG. 6B and the measurements in Table 5, for the electrode Y3, the Equation 5′ becomes:

G(Y3)=Vref/V1_{ADC3}×G3−G3,

where V1_{ADC3}=0.5V, Vref=3V, and G3=1/20 mS. Therefore, G(Y3)=0.25 mS, which is corresponding to a 4KΩ resistance. Next, G3% can be computed using Equation 7 as:

G3%=G3/(G3+G(Y3))

where G3=1/20 mS and G(Y3)=0.25 mS. This value may be substituted into Equation 4 (Approach I) to calculate individual conductance value of each inter-electrode resistor on the electrode Y3.

If the force sensor comprises many electrodes, the relative conductance of the reference resistor Rm, Gm %, may be a small number and subject to a high noise-to-signal ratio using Equation 3 of Approach I. Contrarily, the Equation 7 of Approach II may have better accuracy in computing Gm % by using known conductance value of the reference resistor and the conductance value of the electrode based upon measurement. Therefore, using steps in Approach II and Equation 7 may result in improved accuracy for location and force magnitude information.

In some embodiments, the measurement values collected in Approach II may be used to modify the relative conductance computed in Approach I. In an exemplary embodiment, Y array correction factors, which include one factor for each Y array electrode, are determined based upon relative conductance developed by Approach II. For example, the relative conductance of the inter-electrode resistor at the intersection I4e is about 2 times of the relative conductance of the inter-electrode resistor at the intersection I4e in Table 7, as the ratio of ‘row 4’ verse ‘row 3’ is about 2.0. However, the values in Table 4 computed in Approach I indicate a relative conductance ratio of 1.5 (50.00%/33.33%) at the intersection I4e verse intersection I3e. Y array correction factors for Y3 and Y4 could be determined, for example, as [2.0 1.5].

In an exemplary embodiment, a column with highest relative conductance, computed by Approach II, is selected. In the example of Table 7, column ‘e’ is selected and replicated in column ‘Approach II’ in Table 8. Then, the relative conductance of electrode intersection is normalized, as illustrated in column ‘Normalized’ in Table 8. The correction factors may be determined as the normalized conductance value of Approach II divided by the relative conductance of Approach I. The same column in Table 3 is replicated in column ‘Approach I’ in Table 8. The correction factors may be determined as ‘Normalized’/‘Approach I’, shown in column ‘Factors’.

TABLE 8
Y Array Correction Factors

| Approach II | Normalized | Approach I | Factors |
|---|---|---|---|
| 0.00% | 0.00 | 0.03% | 0.00 |
| 121.10% | 1.00 | 66.67% | 1.50 |
| 60.54% | 0.50 | 33.33% | 1.50 |
| 121.04% | 1.00 | 50.00% | 2.00 |
| 30.27% | 0.25 | 16.67% | 1.50 |

The Y array correction factors may be applied to the computation results of Approach I. In some cases, relative conductance values of inter-electrode resistors of Approach I may be multiplied by a corresponding Y array correction factor. Table 9 illustrates a corrected relative conductance matrix from Table 2 applying the Y array correction factors in Table 8.

TABLE 9
Corrected Relative Conductance in Percentage

| ADC | a | b | c | d | e | Factors |
|---|---|---|---|---|---|---|
| 1 | 0.00% | 0.00% | 0.00% | 0.00% | 0.00% | 0.00 |
| 2 | 0.05% | 25.00% | 0.05% | 0.05% | 100.00% | 1.50 |
| 3 | 25.00% | 50.00% | 0.05% | 0.05% | 50.00% | 1.50 |
| 4 | 0.07% | 24.99% | 0.07% | 49.98% | 99.95% | 2.00 |
| 5 | 0.05% | 0.05% | 100.00% | 0.05% | 25.00% | 1.50 |

The exemplary sensor is only 5×5, four maxima of significant conductance provide multiple overlapping measured signals, and the simulated measurement system is noise-free, so correction factors shown in the examples are very accurate. In practice, correction factors should be applied only in areas of the sensor where measured signals are above a predetermined threshold value to ensure that noise is not a significant portion of the measurement. For example, a sensor with 50 X electrodes and 100 Y electrodes may have two measured maxima near opposite corners. If each local maximum has above-threshold signals spanning three electrodes, the large area of below-threshold signals near the center of the sensor should not and need not have row-to-row correction factors calculated. Only the rows in the vicinity of each maximum require correction in order to accurately locate the position of each local maximum by interpolation.

Location information of one or more contacts on the force sensor may be determined based upon the relative conductance values. In some embodiments, the location information of one or more contacts is determined by finding the intersection having a local maximum relative conductance value among the relative conductance values of adjacent intersections. For example, peak values at 3b, 5c, 2e, and 4e in Table 9 indicate four contacts (or maximum pressure points) near these locations. In some cases, interpolation using known methods can be applied to resolve more precise touch locations using these values. For example, Table 9, column ‘b’ has a peak value of 50.00% at 3b, flanked by 2b=25.00% and 4b=24.99%. Interpolation among these three values indicates a peak force on the 3b intersection. If 2b were 40.00% instead of 25.00%, interpolation would indicate a peak force centered slightly above 3b, closer to 2b than 4b.

In some embodiments, the control system of the force sensitive device can be configured with a wake-on-touch feature. In an exemplary embodiment, the control system comprises analog-to-digital convertors with interrupt-on-change enabled. In such configuration, a change occurs to the receive signal received by an analog-to-digital convertor when a contact is imposed on the sensor. The analog-to-digital convertor may generate an output signal wake up the control system. A threshold value may be predetermined for the wake-on-touch feature such that the control system will wake up when the contact force is higher than a predetermined value.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A force sensitive device, comprising:
a force sensitive sensor comprising:
a first array of input electrodes on a first layer;
a second array of electrodes on a second layer, the second array of electrodes arranged transverse to the first array of electrodes to form intersections where electrodes of the first array cross electrodes of the second array; and
force sensitive resistive material disposed between the first layer and the second layer at least some of the intersections;
a signal source coupled to the first array of electrodes and configured to provide a drive signal to one or more electrodes thereof;
a measurement circuit coupled to the second array of electrodes and configured to measure voltage signals thereon, wherein the interface between the measurement circuit and the second array of electrodes is passive; and
a processing unit configured to determine location information related to a contact on the force sensitive sensor based upon the signals received by the measurement circuit.

2. The force sensitive device of claim 1, wherein the first array of input electrodes is not directly coupled to the measurement circuit.

3. The force sensitive device of claim 1, wherein the signals received by the measurement circuit are voltage signals.

4. The force sensitive device of claim 1, wherein the signal source comprises a current source.

5. The force sensitive device of claim 1, wherein the signal source comprises a voltage source.

6. The force sensitive device of claim 1, wherein location information comprises the coordinates of the contact.

7. The force sensitive device of claim 1,
wherein the signal source provides a first drive signal to at least one input electrodes of the first array at a time and the measurement circuit receives first receive signals on the second array of electrodes, the first receive signals responsive to the first drive signal, and
wherein the location information is developed based upon the first receive signals received by the measurement circuit.

8. The force sensitive device of claim 7, wherein the first drive signal is a voltage.

9. The force sensitive device of claim 1,
wherein the signal source provides a second drive signal to electrodes of the second array, while the signal source provides high impedance to at least one input electrodes of the first array at a time, to produce second receive signals on the second array of electrodes that are responsive to contact force applied to the force sensitive sensor,
wherein the measurement circuit receives the second receive signals on the second array of electrodes, and
wherein the location information is developed based upon the second receive signals received by the measurement circuit.

10. The force sensitive device of claim 9, wherein the signal source comprises tri-state drivers having a high signal state, a low signal state, and a high impedance state.

11. The force sensitive device of claim 9, wherein the high impedance is greater than 100 K ohms.

12. The force sensitive device of claim 9, wherein the second drive signal is a voltage.

13. The force sensitive device of claim 7,
wherein the signal source provides a second drive signal to electrodes of the second array, while the signal source provides high impedance to at least one the input electrodes of the first array at a time, to produce second receive signals on the second array of electrodes that are responsive to contact force applied to the force sensitive sensor,
wherein the measurement circuit receives the second receive signals on the second array of electrodes, and
wherein the location information is developed based upon the first receive signals and the second receive signals received by the measurement circuit.

14. The force sensitive device of claim 13, wherein the signal source comprises tri-state drivers having a high signal state, a low signal state, and a high impedance state.

15. The force sensitive device of claim 13, wherein the high impedance is greater than 100 K ohms.

16. The force sensitive device of claim 13, wherein the second drive signal is a logic high voltage.

17. The force sensitive device of claim 1, wherein the input electrodes of the first array are substantially parallel to one another.

18. The force sensitive device of claim 1, wherein the electrodes of the second array are substantially parallel to one another.

19. The force sensitive device of claim 1, wherein the first array of input electrodes are substantially perpendicular to the second array of electrodes.

20. The force sensitive device of claim 1, wherein the processing unit is configured to determine location information of a plurality of temporally overlapping contacts on the force sensitive sensor based upon the signals received by the measurement circuit.

21. The force sensitive device of claim 1, wherein the processing unit configured to determine force magnitude information of the contact on the force sensitive sensor based upon the signals received by the measurement circuit.

22. A method for determining location information related to a contact made on a touch sensitive surface of a device, the touch sensitive surface having a first array of drive electrodes on a first layer, a second array of electrodes on a second layer, the electrodes of the second array of electrodes arranged transverse to the first array to form intersections where electrodes of the first array cross electrodes of the second array, and force sensitive resistive material disposed between the first layer and the second layer at least some of the intersections, the method comprising:
(1) applying a drive signal by a signal source to at least one drive electrode of the first array while applying a reference signal to the other electrodes of the first array;
(2) receiving first receive signals occurring on the second array of electrodes, the first receive signals responsive to contact made to the touch sensitive surface, by a measurement circuit passively interfaced to the second array of electrodes;
(3) repeating step (1) and step (2) for at least a plurality of electrodes of the first array; and
(4) based on the first receive signals, determining by a processing unit location information related to the contact made to the touch sensitive surface.

23. The method of claim 22, wherein the first array of drive electrodes is not directly coupled to the measurement circuit.

24. The method of claim 22, wherein the signal source comprises a current source.

25. The method of claim 22, wherein the signal source comprises a voltage source.

26. The method of claim 22, wherein location information comprises the coordinates of the contact.

27. The method of claim 22, wherein the drive signal is a logic high voltage and the reference signal is a ground voltage.

28. The method of claim 27, wherein step (4) comprises computing relative conductance at the intersections based upon the first receive signals and determining the location information based upon a local maximum of the relative conductance.

29. The method of claim 28, wherein step (4) further comprises determining the location information related to the touch by interpolating the relative conductance.

30. The method of claim 22, further comprising:
(5) applying, by the signal source, a high impedance to at least one electrode of the first array while providing the reference signal to the other electrodes of the first array;
(6) receiving second receive signals, by the measurement circuit, occurring on the second array of electrodes;
(7) repeating step (5) and step (6) for at least a plurality of electrodes of the first array; and
(8) based upon the first receive signals and the second receive signals, determining by the processing unit the location information related to the contact made on the touch sensitive surface.

31. The method of claim 30, wherein the high impedance is greater than 100K ohms.

32. The method of claim 30, wherein step (8) comprises adjusting relative conductance computed by step (4) based upon the second receive signals and determining the location information related to the contact based upon the local maximum of the relative conductance.

33. A force sensitive device, comprising:
a force sensitive sensor comprising:
a first array of input electrodes,
a second array of electrodes, and
force sensitive resistive material disposed between the electrodes of the first array and the second array;
a signal source coupled to the first array of electrodes and configured to provide a drive signal to one or more electrodes thereof;
a measurement circuit coupled to the second array of electrodes and configured to measure voltage signals thereon; and
a processing unit configured to determine location information related to a contact on the force sensitive sensor based upon the signals received by the measurement circuit.

34. The force sensitive device of claim 33, wherein the first array of input electrodes is not directly coupled to the measurement circuit.

35. The force sensitive device of claim 33, wherein the interface between the measurement circuit and the second array of electrodes is passive.

36. A force sensitive device, comprising:
a force sensitive sensor comprising:
a first array of input electrodes,
a second array of electrodes, and
force sensitive resistive material disposed between the electrodes of the first array and the second array;
a signal source coupled to the first array of input electrodes and configured to provide a drive signal to one or more electrodes and configured to provide a high impedance to one or more electrodes thereof;
a measurement circuit coupled to the second array of electrodes and configured to measure signals thereon; and
a processing unit configured to determine force information related to pressure applied on the force sensitive sensor based upon the signals received by the measurement circuit.

37. The force sensitive device of claim 36, wherein the first array of input electrodes is not directly coupled to the measurement circuit.

38. The force sensitive device of claim 36, wherein the processing unit configured to determine location information related to the pressure applied on the force sensitive sensor based upon the signals received by the measurement circuit.
